(19) United States
(12) Patent Application Publication
(10) Pub. No.: US 2023/0168438 A1
(43) Pub. Date: Jun. 1, 2023

(54) FIBER OPTIC ADAPTER

(71) Applicant: Senko Advanced Components, Inc., Hudson, MA (US)

(72) Inventors: Chun Pan CHUNG, Scarborough (CA); Man Ming HO, Kowloon (HK); Joe WONG, Kowloon (HK); Siu Kei MA, Kowloon (HK); Kazuyoshi TAKANO, Tokyo (JP)

(73) Assignee: Senko Advanced Components, Inc., Hudson, MA (US)

(21) Appl. No.: 18/073,322

(22) Filed: Dec. 1, 2022

Related U.S. Application Data
(60) Provisional application No. 63/281,656, filed on Dec. 1, 2021.

(51) Int. Cl. G02B 6/38

(52) U.S. Cl. CPC G02B 6/3825; G02B 6/3831

(57) ABSTRACT

The fiber optic adapter may include a main body having a first end portion and a second end portion spaced apart along a length direction, the first end portion having at least a first port configured for receiving at least one ferrule, the second end portion having at least a second port configured for receiving a fiber optic connector; and a sleeve holder provided within the main body and between the first end portion and second end portion such that the first port is in communication with the second port to establish an optical connection. The first port has holding elements to define a receiving space to receive the ferrule, and the receiving space is configured to be expanded when inserting the at least one ferrule into the first port. The fiber optic adapter may receive a ferrule without the need of an outer housing or a spring.

### CROSS-REFERENCE TO RELATED APPLICATION

The present invention claims priority to U.S. Provisional Patent Application No. 63/281,656 filed on Dec. 1, 2021, the disclosure of which is incorporated hereby by reference in its entirety.

### FIELD OF THE INVENTION

The present invention generally relates to optical adapters configured to receive one or more fiber optic connectors in general and, more particularly, to fiber optic adapters for mating multiple fiber optic ferrules and fiber optic connectors.

### BACKGROUND

Modern high-capacity optical systems often utilize fiber optic connectors and adapters for inter-system connection. As there are multiple connection points in an optical path, there is a need for mating two fiber optic ferrules or a ferrule to another connector. In the mating of two fiber optic ferrules or a ferrule and a connector, mechanical and optical alignment is paramount. Slight misalignment can result in significant signal loss, especially in the case of LC ferrules and connectors. Therefore, there is a need for an adapter that can hold and secure one or more fiber optic ferrules and a connector in alignment with precision. Further, the adapter should be durable in design and/or material for repeated installations and uninstallations.

U.S. patent Ser. No. 11/372,168B2 (assigned to the assignee of the present application) discloses a fiber optic adapter receiving a multi-fiber ferrule at a first end and receive a fiber optic connector comprising a multi-fiber ferrule at a second end. However, it fails to disclose an adapter receiving LC ferrule(s) at the first end and a fiber optic connector at the second end.

Those skilled in the art would appreciate a fiber optic connector that receives LC ferrule(s) at the first end and a fiber optic connector at the second end.

### SUMMARY

The present invention is directed to a fiber optic adapter that receives a bare ferrule at one end and a fiber optic connector at the other end. The ferrule is snap-fitted within the fiber optic adapter without a ferrule housing and a spring.

In one aspect of the present invention, the fiber optic adapter may comprise a main body having a first end portion and a second end portion spaced apart along a length direction, the first end portion having at least a first port configured for receiving at least one ferrule assembly, the second end portion having at least a second port configured for receiving a fiber optic connector; and a sleeve holder provided within the main body and between the first end portion and second end portion such that the first port is in communication with the second port to establish an optical connection. The first port has a pair of holding elements defining a receiving space to receive at least one ferrule assembly, and the receiving space is configured to be expanded when inserting at least one ferrule assembly into the first port.

In the fiber optic adapter, the ferrule or ferrule assembly may be in direct contact with the holding elements without an outer housing accommodating the ferrule or ferrule assembly. Also, no spring is needed on the first end portion to keep close contact between the ferrules in the first and second ports. Therefore, the overall size of the adapter is greatly reduced.

In another aspect of the present invention, the fiber optic adapter may comprise a main body having a first end portion and a second end portion spaced apart along a length direction, the first end portion having two first ports each configured for receiving a ferrule assembly, the second end portion having two second ports to receive a duplex fiber optic connector; and a sleeve holder provided within the main body and between the first end portion and second end portion such that the first port is in communication with the second port to establish an optical connection. Each first port has a pair of holding elements defining a receiving space to receive the ferrule assembly, and the receiving space is configured to be expanded when inserting the ferrule assembly into the first port.

In yet another aspect of the present invention, the fiber optic adapter may comprise a main body having a first end portion and a second end portion spaced apart along a length direction, the first end portion having a first port configured for receiving two ferrule assemblies, the second end portion having a second port configured to receive a duplex fiber optic connector; and a sleeve holder provided within the main body and between the first end portion and second end portion such that the first port is in communication with the second port to establish an optical connection. The first port defines two receiving spaces arranged in a vertical direction to receive the ferrule assemblies, and each receiving space is configured to be expanded when inserting the ferrule assembly into the first port.

### BRIEF DESCRIPTION OF THE DRAWINGS

The present invention will become more fully understood from the detailed description given hereinbelow and the accompanying drawings, which are given by illustration only, and thus are not limitative of the present disclosure, and wherein:

FIG. 1 is a perspective view of a fiber optic adapter in accordance with the first embodiment of the present invention, which receives a fiber optic connector at one end and ferrule assemblies at the other end,

FIG. 2A is a perspective view of the ferrule fitted with the fiber optic adapter of FIG. 1, FIG. 2B is a side view of the ferrule of FIG. 2A and FIG. 2C is a front view of the ferrule of FIG. 2A,

FIG. 3 is a perspective view showing the fiber optic adapter before the fiber assemblies are preinstalled,

FIGS. 4A and 4B are section views of the fiber optic adapter of the first embodiment in accordance with the present invention,

FIGS. 5A and 5B show the process of installing the ferrule assembly into the fiber optic adapter,

FIGS. 6A, 6B and 6C show the process of mating the fiber optic connector 70,

FIG. 7 is a perspective view of a second embodiment of the fiber optic adapter in accordance with the present invention,

FIG. 8 is a perspective view showing the installation of the fiber optic adapter of FIG. 7,

FIGS. 9A and 9B are top and front views of the fiber optic adapter of FIG. 7, respectively,

FIG. 10A is a perspective view of the ferrule fitted with the fiber optic adapter of FIG. 7, and FIG. 10B is a side view of the ferrule of FIG. 10A,

FIGS. 11A and 11B are section views of the fiber optic adapter of FIG. 7,

FIGS. 12A-12D show the process of assembling the ferrule assembly,

FIGS. 13A-13C show a third embodiment of the fiber optic adapter in accordance with the present invention, wherein the ferrule assembly has been preinstalled,

FIGS. 14A-14C show a fourth embodiment of the fiber optic adapter in accordance with the present invention, wherein the ferrule assembly has been preinstalled,

FIG. 15 a perspective view of the fifth embodiment of the fiber optic adapter in accordance with the present invention receiving a plurality of ferrule assemblies and a plurality of fiber optic connector,

FIG. 16 is a perspective view of the fifth embodiment of the fiber optic adapter in accordance with the present invention,

FIGS. 17A and 17B are side views of the fiber optic adapter of FIG. 16,

FIG. 18 is a section view of the fiber optic adapter of FIG. 16

FIG. 19 is a section view of the fiber optic adapter of FIG. 16 with the ferrule assembly and fiber optic connector mated,

FIG. 20A is a section view of the fiber optic adapter of FIG. 16, and FIG. 20B is another section view of the fiber optic adapter with the ferrule assemblies preinstalled,

FIG. 21 shows the application of a tool to preinstall the ferrule assembly,

FIG. 22 is a perspective view of the tool of FIG. 21, and

FIGS. 23A and 23B are section views of removing the ferrule assembly by using the tool.

### DETAILED DESCRIPTION

The present invention will now be described more fully hereinafter with reference to the accompanying drawings showing preferred embodiments of the invention. The invention may, however, be embodied in many different forms and should not be construed as limited to the embodiments set forth herein; rather, these embodiments are provided so that the disclosure will fully convey the scope of the invention to those skilled in the art. The drawings are not necessarily drawn to scale but are configured to clearly illustrate the invention. Whenever possible, the same reference numerals will be used throughout the drawings to refer to the same or the like parts.

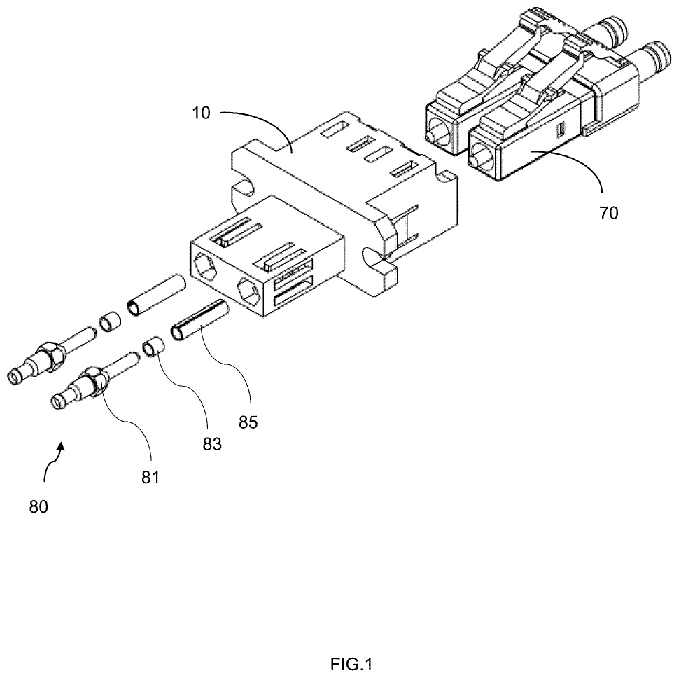

FIG. 1 shows a first embodiment of a fiber optic adapter 10 receiving two LC ferrule assemblies 80 at one end and a fiber optic connector 70 at the other end. Each ferrule assembly 80 may include a ferrule 81, splicer 83, and sleeve 85. The fiber optic connector 70 is a LC type of connector that includes two ferrules. The ferrule assemblies 80 and the fiber optic connector 70 may be inserted into the fiber optic adapter 10 from the respective side to establish an optical connection.

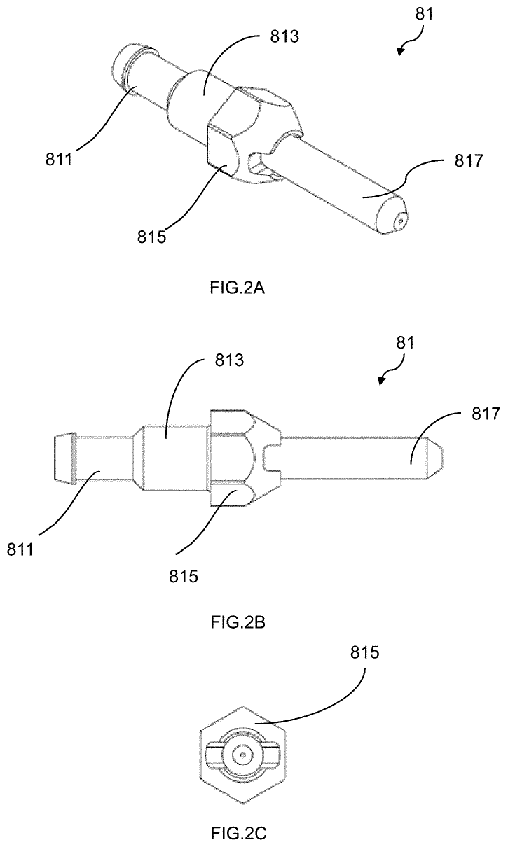

The ferrule 81 that fits the adapter 10 is shown in FIGS. 2A and 2B. The ferrule 81 may include a rear portion 811, snap portion 813, flange 815, and tip portion 817. Generally, the flange 815 may define the dimension of the ferrule 81 in a width direction. The flange 815 may have different shapes and the flange 815 has a hexagon shape as shown in FIG. 2C. In this example, the ferrule 81 is a UPC (“Ultra Physical Contact”) type of flange. The ferrule 81 also includes a central passage (not shown) through which a fiber could pass.

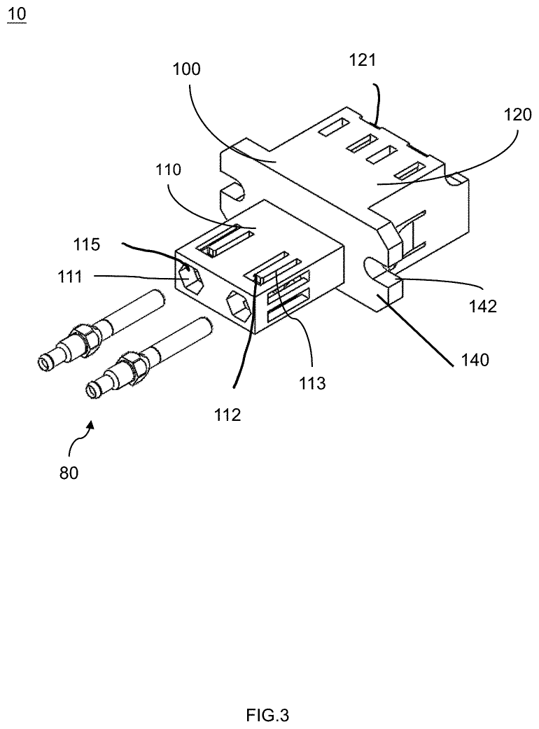

Turning to FIG. 3, the fiber optic adapter 10 includes a main body 100 having a first end portion 110 and a second end portion 120 spaced apart along a length direction. The first end portion 110 is configured to receive ferrule assemblies 80. In detail, the first end portion 110 includes two first ports 111 each configured to receive a ferrule assembly 80 therein. The first port 111 has an entrance 115 that is sized and shaped to allow the ferrule assembly 80 to pass through to be received in the first end portion 110. In this example, the entrance 115 has a hexagon shape corresponding to the flange 815. Those skilled in the art would understand that the shape and size of first port 111 may be adjusted according to the ferrule used. The first end portion 110 includes a top wall and a bottom wall, each having two windows 112. A holding element 113 is provided within the window 112, projecting from one side of the window and extending to the opposite side. In FIG. 3, the holding element 113 extends toward a direction away from the second end portion 120 and is configured to be a flexible arm.

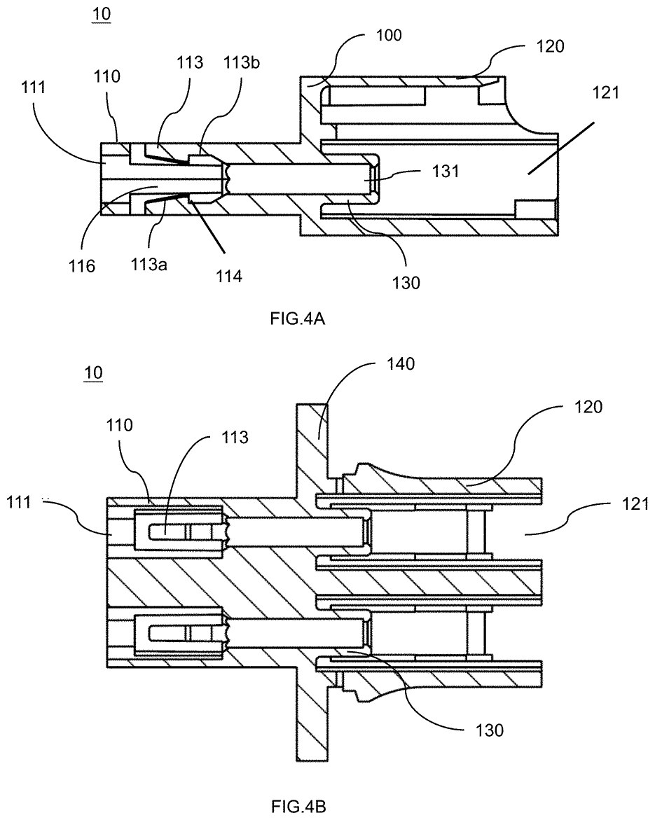

FIGS. 4A and 4B show the section views of the fiber optic adapter 10. The second end portion 120 includes two second ports 121 configured to receive an LC fiber optic connector 70 (as shown in FIG. 1). The connector 70 is a duplex connector and may include a ferrule of 1.25 mm. Those skilled in the art would understand other types of LC ferrule will be used to mate with the ferrule assembly.

The first port 111 and the second port 121 are in communication with each other to establish an optical connection. A sleeve holder 130 is provided within the main body 100 and between the first port 111 and the second port 121 to ensure the alignment of the ferrule assembly 80 in the first port and the fiber optic connector 70 in the second port. In detail, the sleeve holder 130 may receive the tip portion 817 of the ferrule 81 and the ferrule of the fiber optic connector 70.

The holding elements 113 are provided oppositely on the top and bottom walls of the first end portion 110 such that a receiving space 116 is defined in the first port 111 to secure the ferrule 81 within the first port 111. The receiving space 116 is sized and shaped to receive the ferrule 81 including the snap portion 813 and the flange 815. The holding element 113 includes an inclined wall 113a and a groove 113b, both facing the interior space of the first port 111. The inclined wall 113a is configured to be tapered toward the extension direction of the holding element 113 to ease the entering of the ferrule 81. That is, the distance between the opposing inclined walls 113a is decreasing towards the second port 121. The groove 113b is positioned adjacent to the sleeve holder 130 and configured to receive the flange 815. A shoulder 114 is provided between the inclined wall 113a and groove 113b to prevent the movement of the flange 815 from getting out of the groove 113b after the flange 815 is received in the groove 113b. The movement of the ferrule assembly 80 toward the second end portion 120 is prevented by the sleeve holder 130. At this point, the snap portion 813 of the ferrule 81 is clamped by the inclined walls 113a.

The fiber optic adapter 10 also includes an ear plate 140 on both sidewalls of the main body 100 and is provided between the first end portion 110 and the second end portion 120 to install the fiber optic adapter 10 to its position. Each ear plate 140 may include a side hole 141 having an open end (as shown in FIG. 3).

In this example, due to lack of a housing surrounding the ferrule assembly and a spring urging the ferrule assembly, the first end portion may be made smaller than the second end portion in width and length directions. The first end portion may also have a height smaller than the second portion. Thus, a compact size of behind-the-wall fiber optic adapter is obtained.

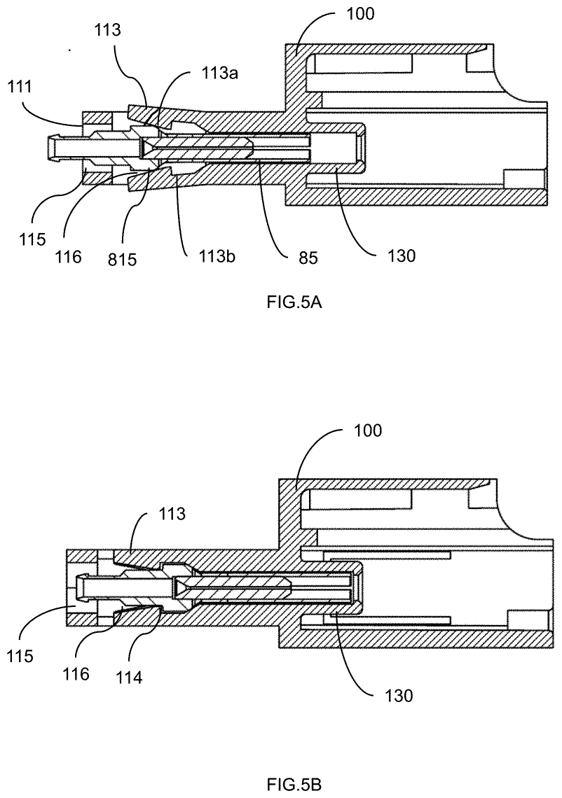

Now referring to FIGS. 5A and 5B, the ferrule assembly 80 is preinstalled into the first end portion 110 through the first port 111. The tip portion 817 may first enter the first port 111 through the entrance 115. When the ferrule assembly 80 moves forward and contacts the inclined walls 113a, the flange 815 may press against the inclined walls 113a and urge the holding elements 113 to move outwards to expand the receiving space 116. Keep moving the ferrule assembly 80 forward, the flange 815 fully passes the inclined walls 113a and is received in the grooves 113b. Then, the holding elements 113 return to the original position. The movement of the ferrule assembly 80 in an opposite direction of the insertion is prevented by the shoulder 114. The tip portion 817 of the ferrule 81 is received in the sleeve holder 130. Thus, the ferrule assembly 80 is secured and pre-installed within the fiber optic adapter 10.

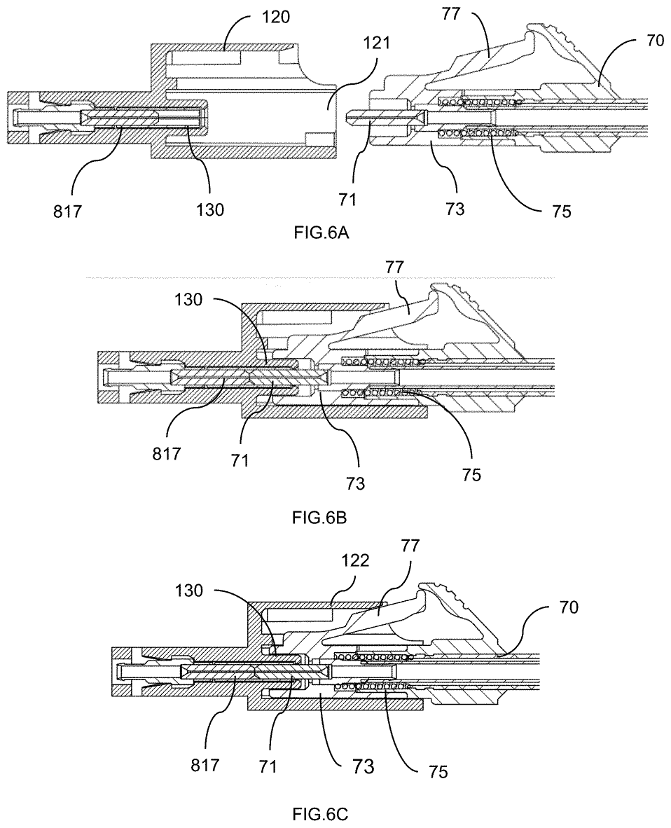

FIGS. 6A, 6B, and 6C show the process of mating the fiber optic connector 70 with the pre-installed ferrule assemblies 80. The fiber optic connector 70 includes a housing 73 accommodating ferrules 71 and a spring 75 configured to apply a bias force to the ferrules 71. The ferrule 71 is exposed from the front end of the housing 73 and moves back and forth under the impact of the spring 75. The housing 73 also includes a latch 77 configured to secure the fiber optic connector 70 to the second end portion 120. When inserting the fiber optic connector 70 through the second port 121, the ferrule 71 is first received in the sleeve holder 130 to be mated with the ferrule 81. Then, the sleeve holder 130 is surrounded by the housing 73 and sandwiched between the ferrule 71 and housing 73. After the ferrule 81 and ferrule 71 mates with each other, the further movement of the ferrule 71 will be prevented by the shoulder 114 in the first end portion 110 such that the spring 75 will be biased if continue moving the fiber optic connector 70 towards the ferrule assembly 80. As shown in FIG. 6C, the spring 75 is biased and urges the ferrule 71 to move forward to be in close contact with the ferrule 81.

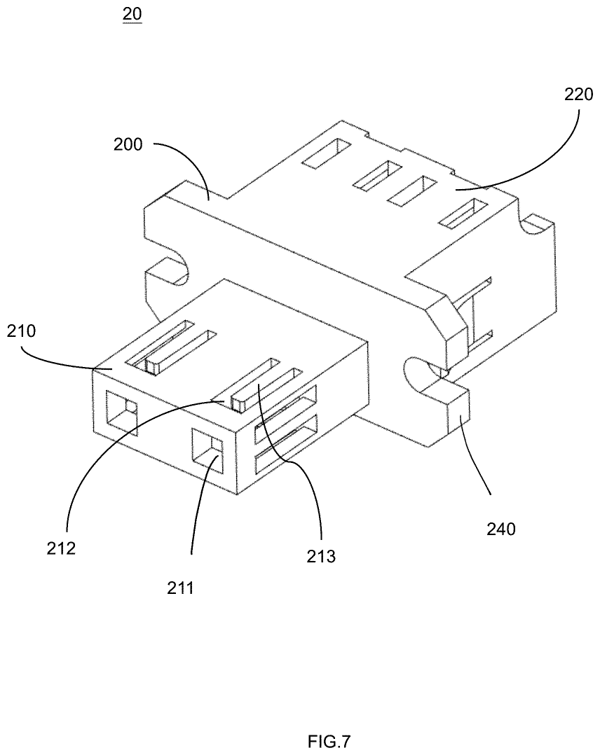

Turning to FIG. 7, the second embodiment of the fiber optic adapter 20 includes the first end portion 210 and the second end portion 220. The fiber optic adapter 20 has a similar structure as the fiber optic adapter 10 but has some changes as a different ferrule is used.

In FIG. 8, the ferrule assembly 80 has been pre-installed in the fiber optic adapter 20. Then, the fiber optic adapter 20 will be installed to one side of the wall 50, and its second end portion 220 will be exposed from the other side of wall 50 to receive the fiber optic connector 70.

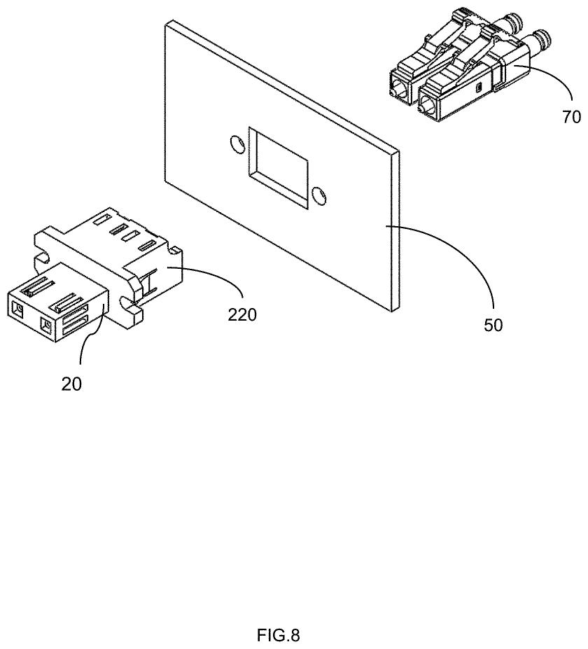

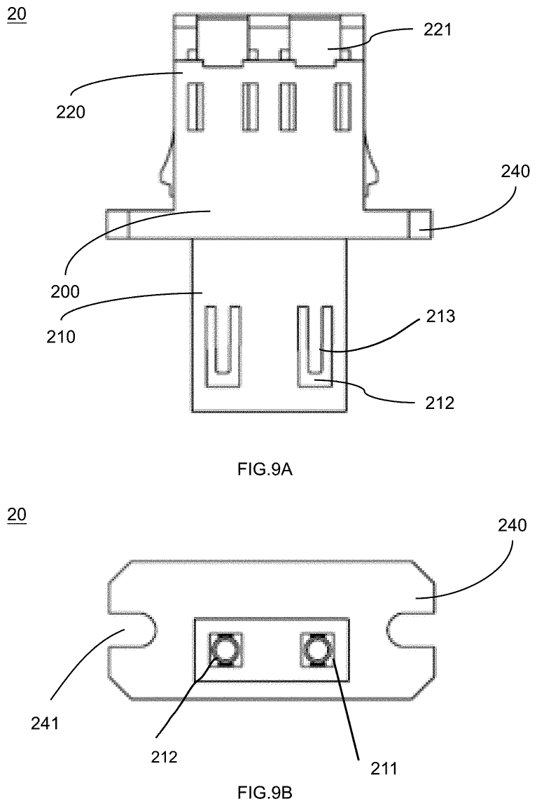

Turning to FIGS. 9A and 9B, the fiber optic adapter 20 includes the main body 200 having the first end portion 210 and the second end portion 220 spaced apart along a length direction. The second end portion 220 includes two ports 221 to receive the fiber optic connector 70. The first end portion 210 includes the top and bottom walls, each having two windows 212. A holding element 213 is provided within the window 212, projecting from one side of the window 212 and extending to the opposite side. In FIG. 9A, the holding element 213 extends toward the direction away from the second end portion 220. An ear plate 240 is provided on each sidewall of the main body 200 and between the first end portion 210 and the second end portion 220 to secure the fiber optic adapter 20 into position. The ear plate 240 includes a side hole 241 having an open end.

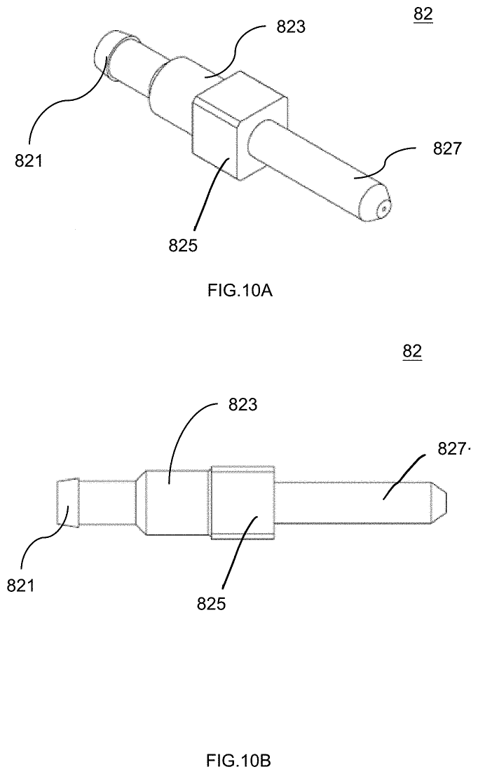

The ferrule 82 that fits the fiber optic adapter 20 is shown in FIGS. 10A and 10B. Similarly, the ferrule 82 may include a rear portion 821, snap portion 823, flange 825, and tip portion 827. Generally, the flange 815 may define the dimension of the ferrule 81 in a width direction. In this example, the flange 825 is an APC (“Angled Physical Contact”) type flange and has approximately a rectangle shape. The ferrule 82 includes a central passage (not shown) through which a fiber could pass.

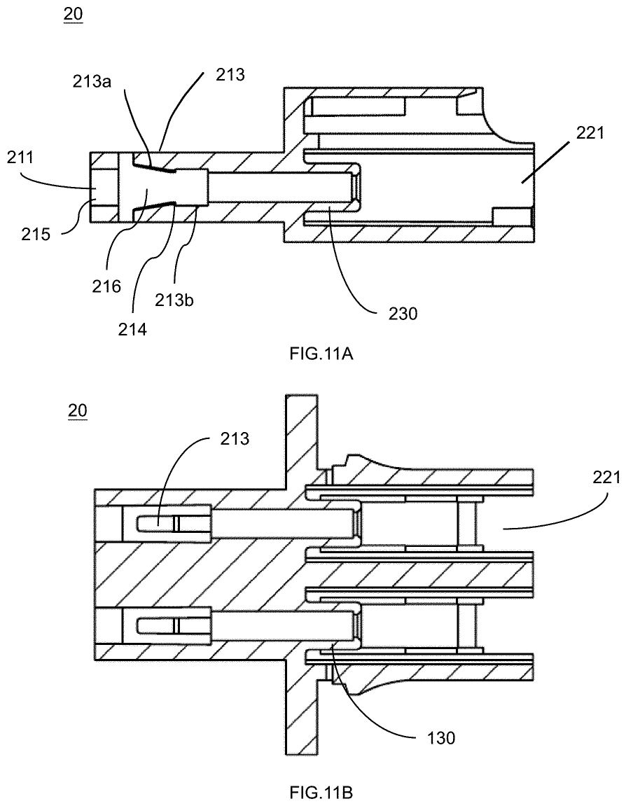

Turning to FIGS. 11A and 11B, each first port 211 has an entrance 215 which is sized and shaped to allow the ferrule assembly 80 to pass through to be received within the first end portion 110. The first port 211 and the second port 221 are in communication with each other to establish an optical connection. The holding elements 213 are provided oppositely on the top and bottom walls such that a receiving space 216 is defined in the first port 211 to secure the ferrule 81 within the first port 211. The holding element 213 includes the inclined wall 213a and groove 213b, both facing the interior space of the first port 211. The inclined wall 213a is configured to be tapered toward the extension direction of the holding element 213. The groove 213b is positioned adjacent to the sleeve holder 230 and configured to receive the flange 825. A shoulder 214 is provided between the inclined wall 213a and groove 213b to prevent the flange 825 from getting out of the groove 213b after the flange 825 is received in the groove 213b. At this point, the snap portion 823 of the ferrule 82 is clamped with inclined walls 213a.

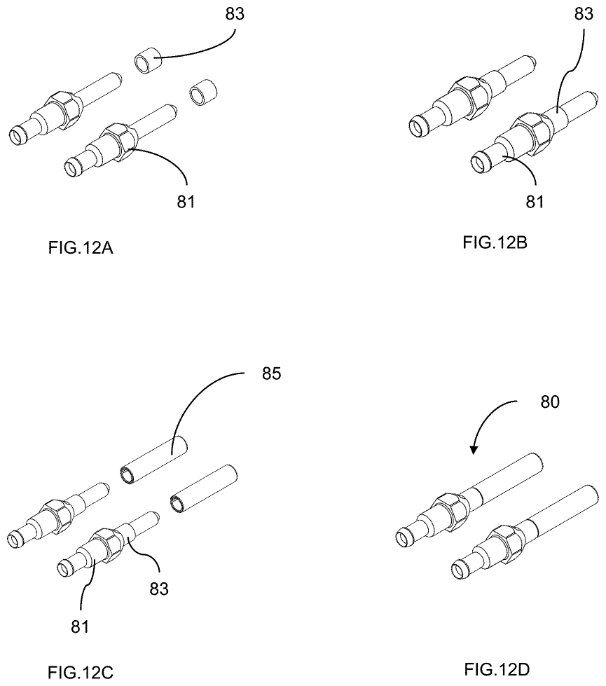

FIGS. 12A-12D show the assembly of the ferrule assembly 80. The spacer 83 is first attached to the ferrule 81, and then the sleeve 85 is attached to the ferrule 81 adjacent to the spacer 83. The sleeve 85 has an elongated length such that a portion of the ferrule 71 is received in the sleeve 85 when in use.

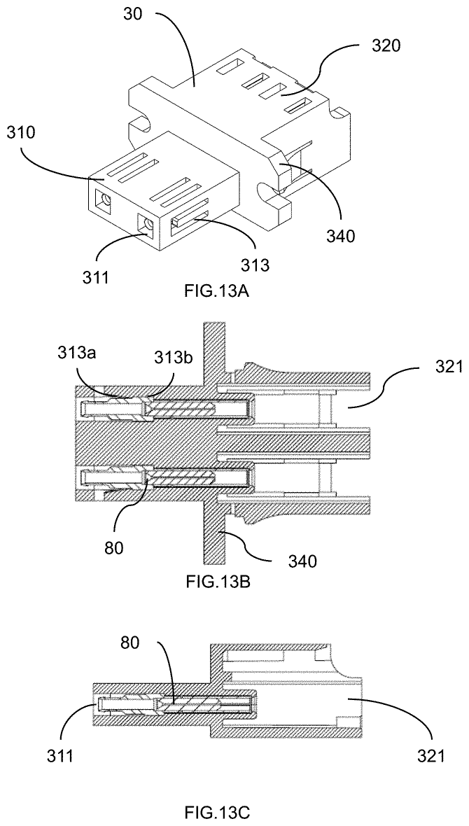

The third embodiment of the fiber optic adapter 30 is shown in FIGS. 13A-13C. In the fiber optic adapter 30, the holding element 313 is provided on each side wall rather than the top and bottom walls of the first end portion 310. Similarly, the holding element 313 also includes an inclined wall 313a and groove 313b to define a space 316 to accommodate the ferrule 82. The holding element 313 is configured to move outwards when inserting the ferrule assembly 80 to the first port 311.

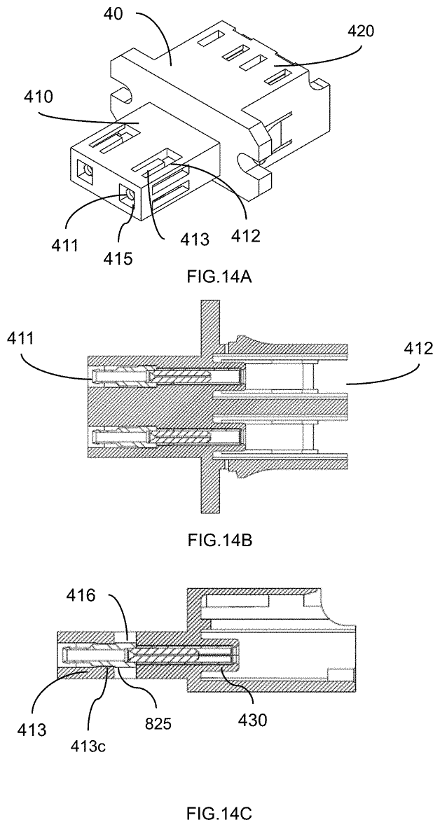

The fourth embodiment of the fiber optic adapter is shown in FIGS. 14A-14C. In the fiber optic adapter 40, the entrance 415 is sized and shaped to allow the ferrule assembly 80 to pass through and the holding element 413 is provided on both top and bottom walls of the first end portion 410. Unlike the holding element 113 and 213, the holding element 413 projects from one side of the window 412 and extends towards the second end portion 420. The holding element 413 may include a step 413c extending from its inner wall at the end close to the second end portion 420. The holding elements 413 and the sleeve holder 430 may define a receiving space 416 to accommodate the ferrule assembly 80. When inserting the ferrule assembly 80, each holding element 413 on the top and bottom walls is deflected and moves outwards to expand the receiving space 416. In detail, the flange 825 forces the holding elements 413 open outwards when the flange 825 contacts the steps 413c and the holding elements 413 return to their original positions once the flange 825 passes over the steps 413c. In this example, the flange 825 is secured between the holding elements 413 and the sleeve holder 430 such that the movement of the ferrule assembly 80 in both directions is prevented.

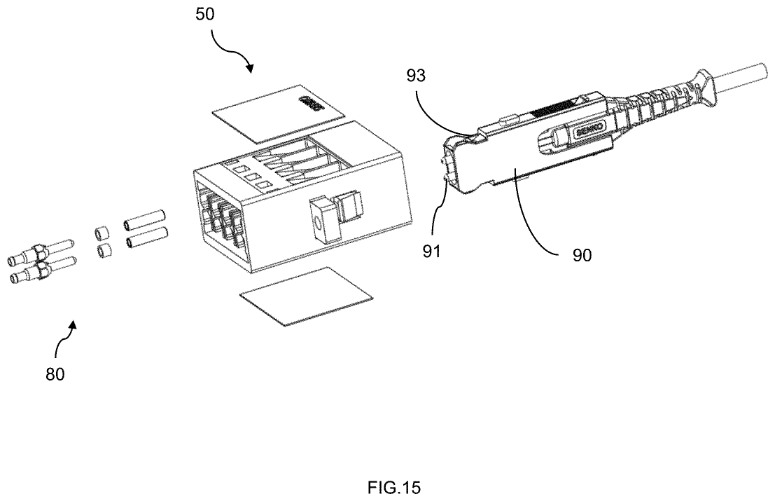

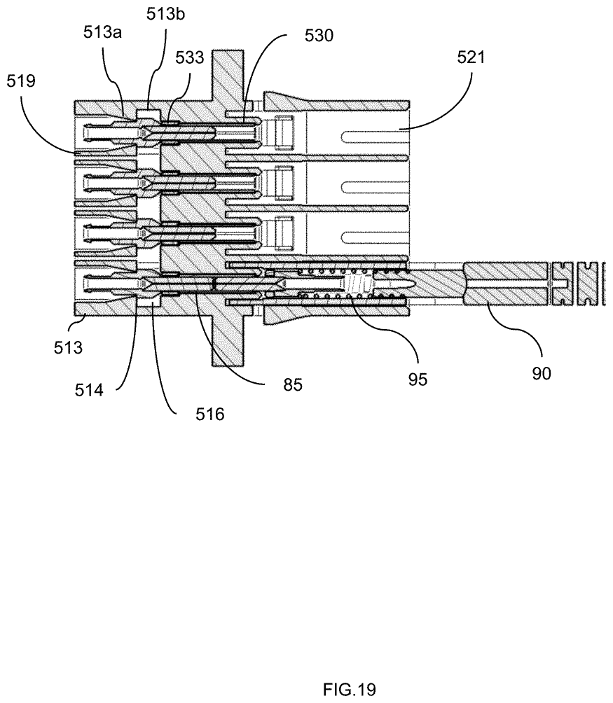

In the following, the fifth embodiment of the fiber optic adapter 50 is described. In FIG. 15, the fiber optic adapter 50 may receive a plurality of ferrule assemblies 80 at one end and a plurality of fiber optic connectors 90 at the other end. In this example, each fiber optic connector 90 includes a pair of ferrules 91, a recess 93, and a spring 95 (as shown in FIG. 19). The ferrules 91 are arranged in a vertical direction.

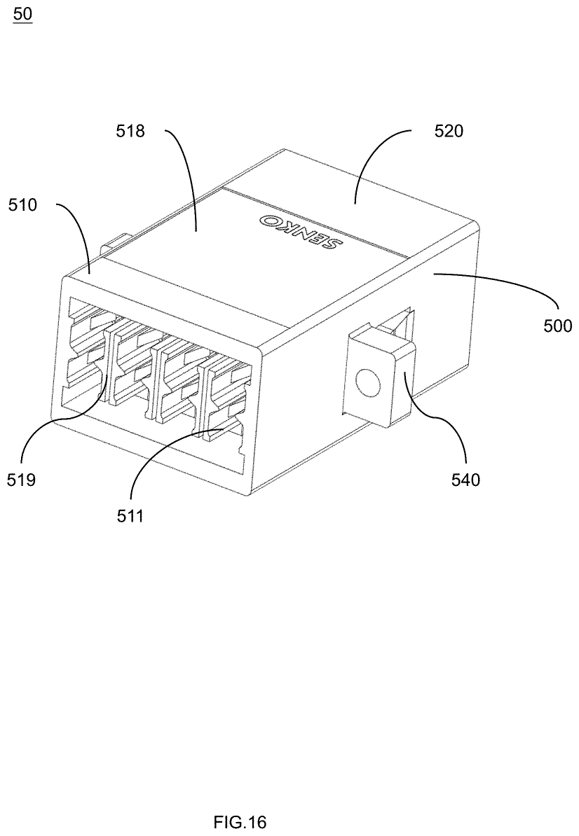

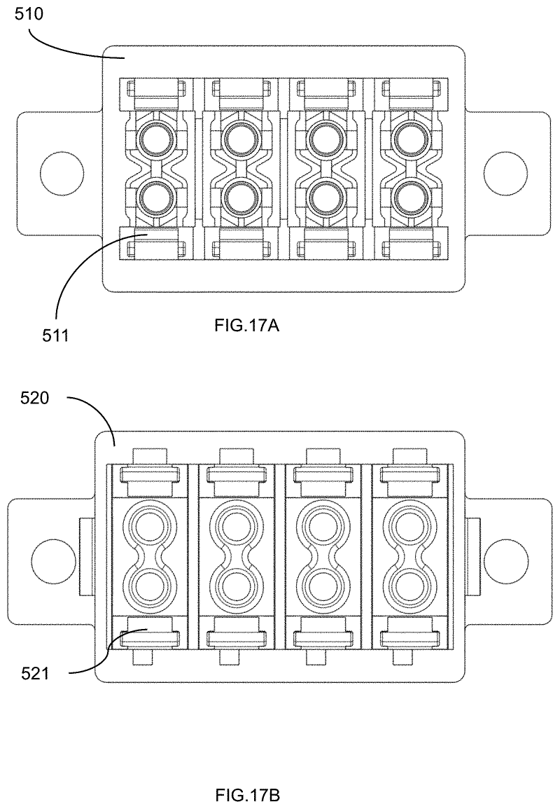

In FIG. 16, the fiber optic adapter 50, similar to the fiber optic adapter 10, may include the main boy 500 having the first end portion 510 and the second end portion 520 spaced apart along the length direction. Unlike the fiber optic adapter 10, the first end portion 510 includes a plurality of first ports 511 each configured to receive a pair of ferrule assemblies 80 arranged in the vertical direction to be mated with the fiber optic connector 90 received within each second port 521 (described in detail below). The first ports 511 are separated by a plurality of intermediate walls 519. The main body 500 may include a removable plate 518 that is removably attached to the top wall. The removable plate 518 may also removably attach to the bottom wall (not shown).

In FIG. 17A, the first end portion 510 includes four first ports 511 each configured to receive a pair of ferrule assemblies 80. In FIG. 17B, the second end portion 520 includes four second ports 521 each configured to receive the fiber optic connector 90.

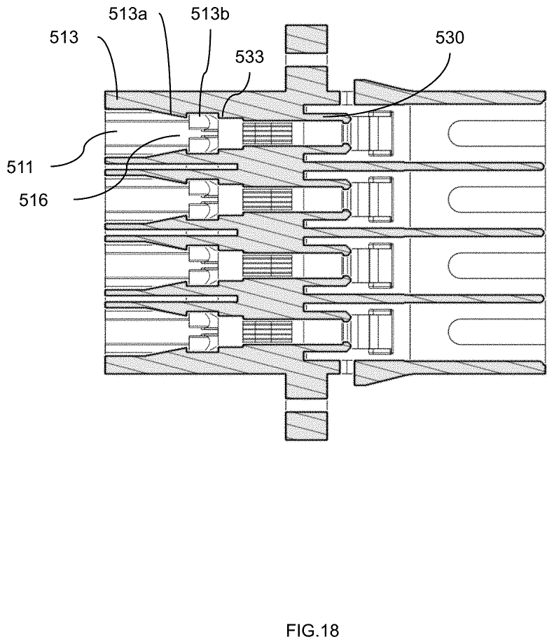

As shown in FIG. 18, each port 511 is provided with a plurality of holding elements 513 each having the inclined wall 513a and the groove 513b. The holding elements 513 may be provided on the side walls of the main body 500 and the intermediate walls 519 separating the first ports 511. The groove 513b is positioned adjacent to the sleeve holder 530. The holding element 513 is oppositely provided in each port 511, in particular on the side walls of each port 511 and may define a receiving space 516 to receive the ferrule assembly 80. In detail, the receiving space 512 is defined by the inclined walls 513a and grooves 513b to receive the snap portion 813 and the flange 815. In inserting the ferrule assembly 80, the flange 815 may contact the inclined walls 513a and force the inclined walls 513a to move outwards such that the receiving space 516 is expanded until the flange 815 passes over the inclined walls 513a and is received within the grooves 513b. Then, the inclined walls 513a return to their original positions. The movement of the ferrule assembly 80 towards the second end portion 320 is prevented by the sleeve holder 530. The sleeve holder 530 is provided a recess 533 at the end adjacent to the holding element 513.

Turning to FIG. 19, the ferrule assemblies 80 are mated with the fiber optic connector 90 within the fiber optic adapter 50 to establish the optical connection. At this point, the tip portion 817 of the ferrule 81 and the front portion of the ferrule 91 are accommodated within the sleeve 85 in the sleeve holder 530 and in close contact with each other. Also, the flange 815 is positioned within the groove 513b and the movement of the ferrule assembly 80 in both directions is prevented by the shoulder 514 and the sleeve holder 530. Thus, the spring 95 is biased and in turn, pushes the ferrules 91 toward the ferrules 81 to maintain close contact therebetween.

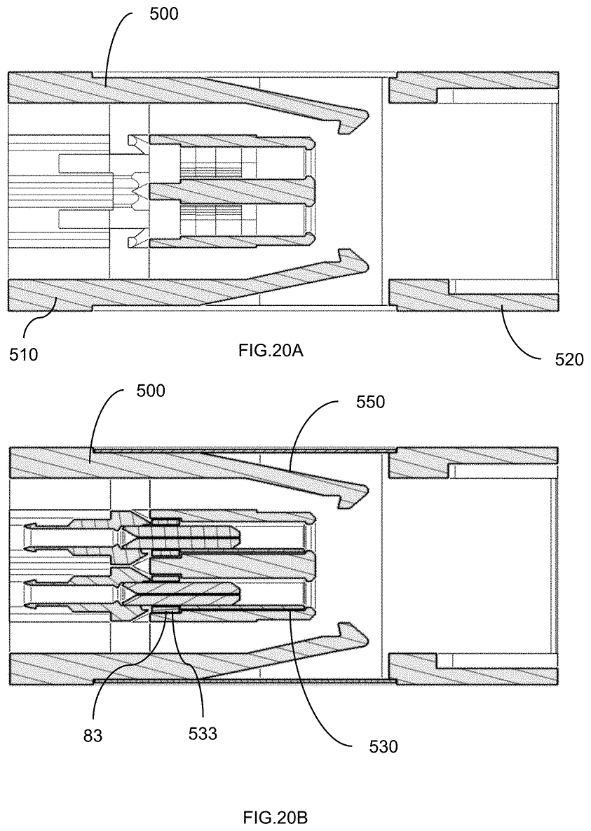

Turning to FIGS. 20A and 20B, the fiber optic adapter 50 also includes a plurality of hooks 550 on both top and bottom walls to secure the fiber optic connectors 90 in position. In detail, the hook 550 is configured to cooperate with the recess 93 of the fiber optic connector 90 to maintain close contact between the ferrule assemblies 80 and the fiber optic connector 90. The hook 550 may be integrated with the main body 500 and extend from the first end portion 510 toward the second end portion 520. To ensure the alignment of the ferrules 81 and 91, the spacer 83 is positioned in the recess 533 and between the flange 815 and the sleeve holder 530.

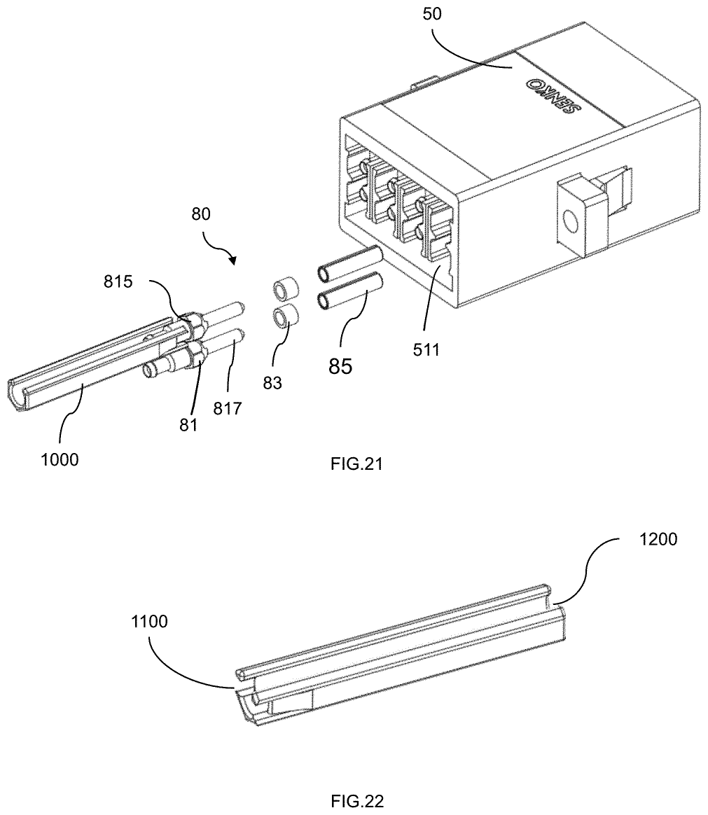

A tool 1000 in FIG. 21, is used to facilitate the installation of the ferrule assembly 80 into the first port 511. The spacer 83 and the sleeve 85 may attach to the tip portion 817 consecutively. Then, the tool 1000 pushes and delivers the ferrule assembly 90 into the first port 511 by holding and clamping the snap portion 813.

In use, the ferrule assembly 80 is preinstalled to the fiber optic adapter 50 before the fiber optic adapter 50 is installed to the wall. As shown in FIG. 22, the tool 1000 may have the shape of an elongated cylinder having a slit along its length. The installation tool 1000 may include an installation end 1100 and a removal end 1200 spaced apart along the length direction. The installation end 1100 may be tapered to ensure the snap portion 813 is closely held by the tool 1000.

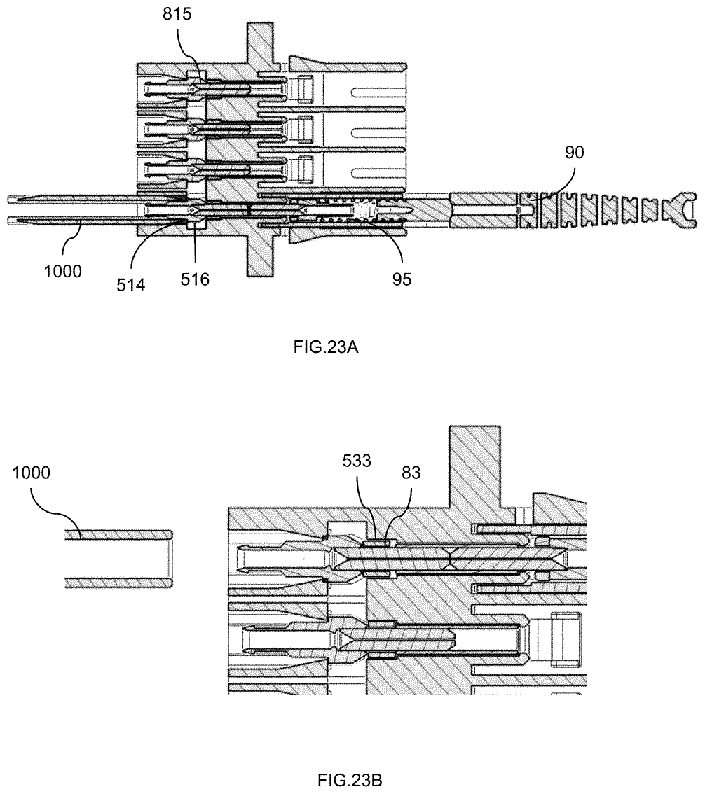

Turning to FIGS. 23A and 23B, to remove the ferrule assembly 80 from the fiber optic adapter 50, the tool 1000, i.e., the removal end 1200 is inserted into the first port 511 to engage with the inclined wall 513a to expand the receiving space 516 such that the flange 815 is released from the groove 513b. When the receiving space 516 is expanded, the flange 815 disengages with the shoulder 514 under the force of the connector, in particular the spring 95, and disconnects with the connector 90. The ferrule assembly 80 may be withdrawn from the first end portion 510 after the tool 1000 is removed.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera).

1. A fiber optic adapter comprising:
a main body having a first end portion and a second end portion spaced apart along a length direction, the first end portion having at least a first port configured for receiving at least one ferrule assembly, the second end portion having at least a second port configured for receiving a fiber optic connector; and
a sleeve holder provided within the main body and between the first end portion and second end portion such that the first port is in communication with the second port to establish an optical connection,
wherein the first port has a pair of holding elements defining a receiving space to receive the at least one ferrule assembly, and the receiving space is configured to be expanded when inserting the at least one ferrule assembly into the first port.

2. The fiber optic adapter according to claim 1, wherein the ferrule assembly includes a ferrule having a flange in the shape of a polygon.

3. The fiber optic adapter according to claim 1, wherein the pair of the holding elements are oppositely provided in the first port, and each holding element includes an inclined wall and a groove, wherein the inclined wall is configured to drive the holding element to move outwards to expand the receiving space when inserting the at least one ferrule assembly into the first port.

4. The fiber optic adapter according to claim 1, wherein the ferrule assembly includes a spacer and a sleeve configured to ensure the alignment of the at least one ferrule assembly and the fiber optic connector.

5. The fiber optic adapter according to claim 1, wherein the second end portion includes another second port to receive a LC fiber optic connector.

6. The fiber optic adapter according to claim 2, wherein the first port includes an entrance, the entrance is sized and shaped to allow the flange to pass through.

7. The fiber optic adapter according to claim 6, wherein the entrance has a polygon shape.

8. The fiber optic adapter according to claim 7, wherein the entrance has a shape of rectangular or hexagon.

9. The fiber optic adapter according to claim 1, wherein the first end portion includes a plurality of the first ports that are separated by a plurality of intermediate walls, each intermediate wall having a holding element.

10. The fiber optic adapter according to claim 1, wherein the first port is configured to receive two ferrule assemblies arranged in a vertical direction.

11. The fiber optic adapter according to claim 10, wherein the main body includes a top wall and bottom wall, each having a hook configured to secure the fiber optic connector received in the second port.

12. The fiber optic adapter according to claim 11, wherein the hook is configured to be integrated with the main body and extend from the first end portion towards the second end portion.

13. The fiber optic adapter of claim 11, wherein the main body includes a plate that is removably attached to the top or bottom wall.

14. The fiber optic adapter of claim 3, wherein the inclined wall is configured to be tapered to ease the entering of the ferrule assembly into the receiving space.

15. The fiber optic adapter of claim 3, wherein the main body is configured to be one piece unit.

16. The fiber optic adapter of claim 3, wherein the first end portion is free of spring.

17. The fiber optic adapter of claim 2, wherein the pair of the holding elements are configured to in direct contact with the ferrule such that the ferrule is clamped between the holding elements immediately.

18. The fiber optic adapter of claim 4, wherein the ferrule assembly is configured to be preinstalled into the first port.

19. A fiber optic adapter comprising:
a main body having a first end portion and a second end portion spaced apart along a length direction, the first end portion having two first ports, each configured for receiving a ferrule assembly, the second end portion having two second ports to receive a duplex fiber optic connector; and
a sleeve holder provided within the main body and between the first end portion and second end portion such that the first port is in communication with the second port to establish an optical connection,
wherein each first port has a pair of holding elements defining a receiving space to receive the ferrule assembly, and the receiving space is configured to be expanded when inserting the ferrule assembly into the first port.

20. A fiber optic adapter comprising:
a main body having a first end portion and a second end portion spaced apart along a length direction, the first end portion having a first port configured for receiving two ferrule assemblies, the second end portion having a second port configured to receive a duplex fiber optic connector; and
a sleeve holder provided within the main body and between the first end portion and second end portion such that the first port is in communication with the second port to establish an optical connection,
wherein the first port defines two receiving spaces arranged in a vertical direction to receive the ferrule assemblies, and each receiving space is configured to be expanded when inserting the ferrule assembly into the first port.
